(19) United States
(12) Patent Application Publication
(10) Pub. No.: US 2004/0137182 A1
(43) Pub. Date: Jul. 15, 2004

(54) Pressure sensitive reinforcement strip for loose leaf pages

(76) Inventor: Phillip E. Messier, LaGrange, KY (US)

Correspondence Address: David W. Carrithers, CARRITHERS LAW OFFICE, One Paragon Centre, 6060 Dutchman's Lane, Suite 140, Louisville, KY, 40205, US

(21) Appl. No.: 10/342,068

(22) Filed: Jan. 14, 2003

(51) Int. Cl. B32B 9/00

(52) U.S. Cl. 428/40.1

(57) ABSTRACT

A longitudinally extending strip of plastics material for reinforcing an edge portion of a loose leaf page wherein one edge of the strip, proximate at least one end thereof, tapers gradually toward the other longitudinal edge in a direction toward the end associated therewith and thereby gradually narrowing allowing the page to which it is attached to be curled from one corner thereof to a greater extent than otherwise would occur if the strip were to be of constant width throughout the length thereof.

### BACKGROUND OF THE INVENTION

1. Technical Field

This invention relates generally to a reinforcement strip for pages inserted into loose leaf binders and principally to pages of an airline pilots flight operation manual.

2. Background of the Invention

Prolonged usage of pages in a loose leaf binder eventually causes them to tear from the rings of the binder. Unless repairs are made the pages get in such disarray that access to the contents of the manual becomes difficult if not impossible. For an airline pilot in desperate need of specific information from an airline pilot's guide or flight operation manual such a situation is intolerable. This problem is discussed in the teachings of U.S. Pat. No. 5,842,720 granted Dec. 1, 1998 to Gary R. Ward entitled ‘Pressure Sensitive Reinforcement Strips for Loose Leaf Pages’.

The forgoing patentee directs attention to a number of United States patents that disclose various reinforcement means for applying to the lateral edge of a page as a reinforcement against tearing. In addition, the following references uncovered in a preliminary novelty search also disclose various strip type page reinforcing means: U.S. Pat. No. 6,309,130 granted Oct. 30, 2001 by Johnson et al; U.S. Pat. No. 5,683,19 granted Nov. 4, 1997 by Emmel et al; U.S. Pat. No. 5,590,972 granted Jan. 7, 1997 by Shobin; and U.S. Pat. No. 3,799,417 granted Mar. 26, 1974 by Williams.

These prior art references disclose various strip type loose leaf page reinforcing means, but in all instances the strip is of constant width throughout the length thereof and thus the page reinforced thereby is stiffened along that portion to which the strip is attached. This restricts curling of the page when one lifts a corner of that page to reveal, i.e. expose content appearing on the page next below. The restriction of the curling of the page limits the amount of reading matter (graphs or other content exposed on that next page and this can cause difficulties to a pilot, (or anyone else as the case maybe), that is quickly flipping through pages looking for specific information in the loose leaf document or manual. The restriction created by a square edged reinforcing strip also creates a stress concentration at the top and bottom of the page where the page meets the reinforcing strip edge leading to page tearing as well.

### SUMMARY OF INVENTION

A loose leaf page reinforcing strip of the present invention has a length corresponding essentially to the length of the page to which it is to be applied and one longitudinal edge of the strip, adjacent at least one of the opposite ends of the strip, is tapered gradually narrowing toward the other opposite marginal edge in a direction toward the end of the strip associated therewith. The taper is in a direction toward the marginal edge of the page being repaired by the strip. The edge of the strip defining the taper is preferably curved. The reinforcing strip of the present invention has many advantages including making it easier to flip the page and it eliminates the stress concentration that often results in tearing of the page such as caused by the prior art strips that are of constant width throughout the length thereof. This narrowed end of the strip allows the associated edge of the page to which it is applied to curl across the entire width of the page and isn't limited to the width of the page less the width of the strip as is the case with the prior art reinforcing strips.

Another object of the present improvement lies in the use of a strip having an adhesive thereon covered by a peelable nonsticking backing wherein the backing includes at least one transverse split spaced apart from the distal ends thereof in order to remove the backing and enable the user to position the strip accurately along the notebook page for accurate alignment of the holes and application of the reinforcement in stages as opposed to removing all of the backing and application of the entire adhesive portion of the strip to the page all at once.

These and other objects of the present invention will be more fully understood from the following description of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is an oblique view showing a loose leaf page reinforcing strip provided in accordance with the present invention;

FIG. 2 is an oblique view showing the loose leaf page of FIG. 1, but from the opposite face of the strip and illustrating adhesive applied to only a portion thereof;

FIG. 3 is a plan view showing a loose leaf page with a strip as shown in FIG. 1 applied thereto;

FIG. 4 is a plan view showing two pages overlying one another and with the top page being a page as shown in FIG. 3 and curled up from one corner to expose the content on the underlying page;

FIG. 5 is an oblique side view showing the application of a strip by alignment and placement thereof on a page wherein the lower portion of the strip includes the backing and the backing is being peeled away from the top portion of the strip for application to the paper;

FIG. 6 is an oblique side view of the embodiment of FIG. 5, showing the second step of the application of a strip wherein a portion of the strip is adhered to the paper and the backing is removed by peeling from the remaining portion of the strip starting from the center and peeling toward the end so that the strip is in alignment with the holes as it is placed upon and adheres to the paper; and

FIG. 7 is an oblique view showing an alternate method of application of the reinforcement strip to a notebook page wherein the strip is applied from the center toward the ends.

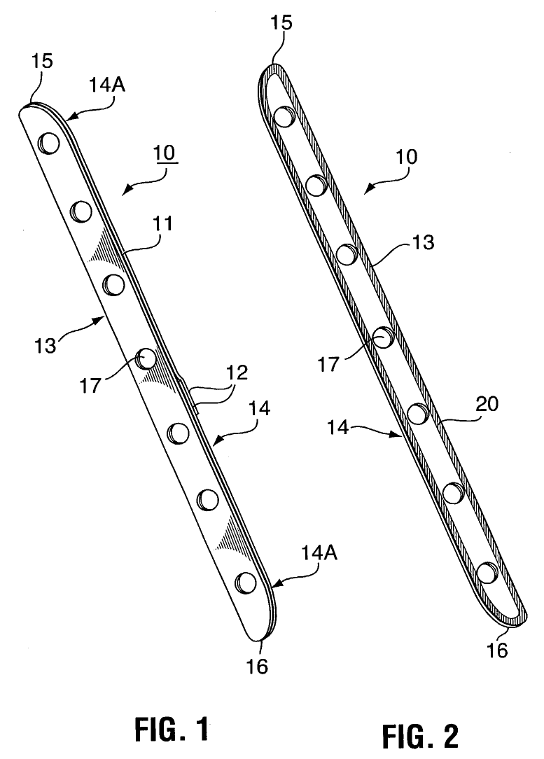

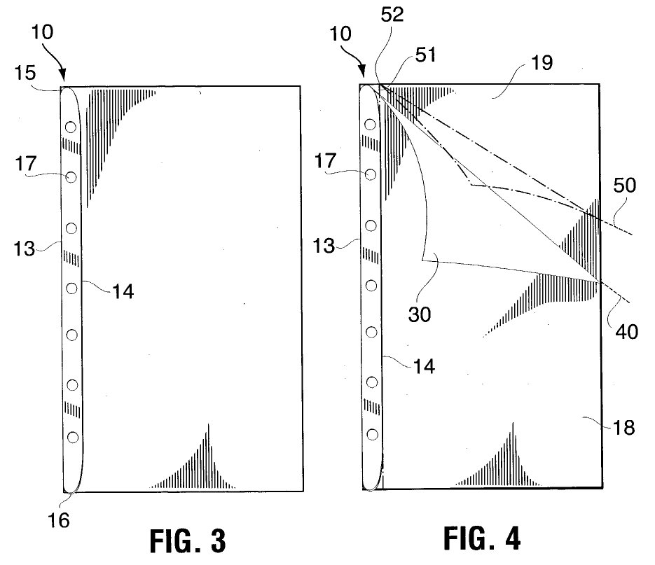

### DESCRIPTION OF THE PREFERRED EMBODIMENTS

Referring to the drawings there is illustrated a loose leaf page reinforcing strip 10 made of a plastic film or sheet 8, such as from MYLAR or the like and having a pressure sensitive adhesive 11 on one surface thereof covered by a peelable nonstick strip or backing 12. The peelable nonstick strip 12 may be fabricated of wax paper, or a paper or plastic film coated with a nonstick substance like a silicon releasably adhering to the pressure sensitive adhesive 11. The strip 10 has longitudinal opposed marginal edges 13 and 14 with the edge 13 being a straight line to coincide with a longitudinal marginal edge of a loose leaf page to which the strip is to be applied. The strip has opposite ends 15 and 16. The edge 14, in accordance with the present invention has a portion 14A at least one of the opposite ends of the strip that tapers toward the opposite longitudinal edge 13 in proximity of the end associated therewith whereby the strip gradually narrows in a direction toward the end of the strip. The sloping portion 14A may slope along a straight line forming an angle, but more preferably is curved as is illustrated in the drawings.

The strip preferably has a series of appropriately spaced precut holes or apertures 17 that align with the rings in the loose leaf binder or series of binders of various sizes in which it is to be used. These however could be initially omitted and later punched out at the time of use or holes could be die cut at selected positions whereby the holes could be removed by punching. While the figures refer to binders having a plurality of rings, the instant invention is applicable to notebooks having at least two rings such as the common three ring binders having sheets sized and punched accordingly.

The pressure sensitive in one embodiment covers the entire face of the strip and in an alternative embodiment, illustrated in FIG. 2, the adhesive is a bead 20 of selected width extending inwardly from and following the outer periphery of the strip either entirely or along only one longitudinal edge, and optionally around the holes or hole die cut perforations.

The peel strip 12 maybe a continuous single length but preferably is two pieces with adjacent ends thereof possibly overlapping to provide finger grip tabs that facilitate removal. Moreover, the use of a strip having an adhesive thereon covered by a peelable nonsticking backing wherein the backing includes at least one transverse split spaced apart from the distal ends thereof in order to enable the user to position the strip accurately along the notebook page for alignment of the holes prior to removing a portion of the backing. The transverse split in the backing may be formed normal to the longitudinal axis of the strip, or at an angle. The interior end edges of the backing may meet at a junction, or one of the proximate end edges of the backing may overlap the other proximate end edge of the backing.

In FIG. 4, there is illustrated a loose leaf page 18 overlying another page 19, which may for example be pages from a flight operators manual, that measure 5.5 inches and 8.5 inches and each having a thickness of 0.002 inches. Pages having the foregoing thickness are flimsy. Moreover, the present invention is useful for holding thin sheets of paper such as those known as ‘onion skin’ or the like. The thickness of the page with the instant reinforcing strip applied thereto is approximately 0.005″. When one lifts the corner 30 of the page 18 to reveal contents on the next page 19, or succeeding pages as the case maybe, curling of the page, without interference from the applied reinforcement strip, continues to approximately the dotted line designated 40. On the other hand, if the strip were to be of constant width, as would be the case with a strip of the prior art, curling of the page would continue only to about the dotted line designated 50 because of interference from the reinforcing strip extending in a straight line as represented by the broken line 51 to the top edge of the page.

Because the reinforcement strip is of considerably greater strength than the paper it is applied, to conventional reinforcement strips having square edges which extend to the upper and lower edges of the paper may prevent ripping of the rings through the holes of the paper; however, the thin paper often tears at the boundary of the reinforcement strip starting at the corner due to the difference in the structural integrity of the paper and the stronger reinforcement strip material. This is especially prone because the sheets are typically gripped toward the edge opposite the rings in order to turn the page, putting great stress on the sheet at the distal end edge of the reinforcement strip at stress point 52 as best illustrated in FIG. 4. Applicant's reinforcement strip utilizing a tapered end whereby the strip gradually narrows in a direction toward the end of the strip provides a gradual yielding of the page corresponding to the taper of the strip dissipating the stress there along.

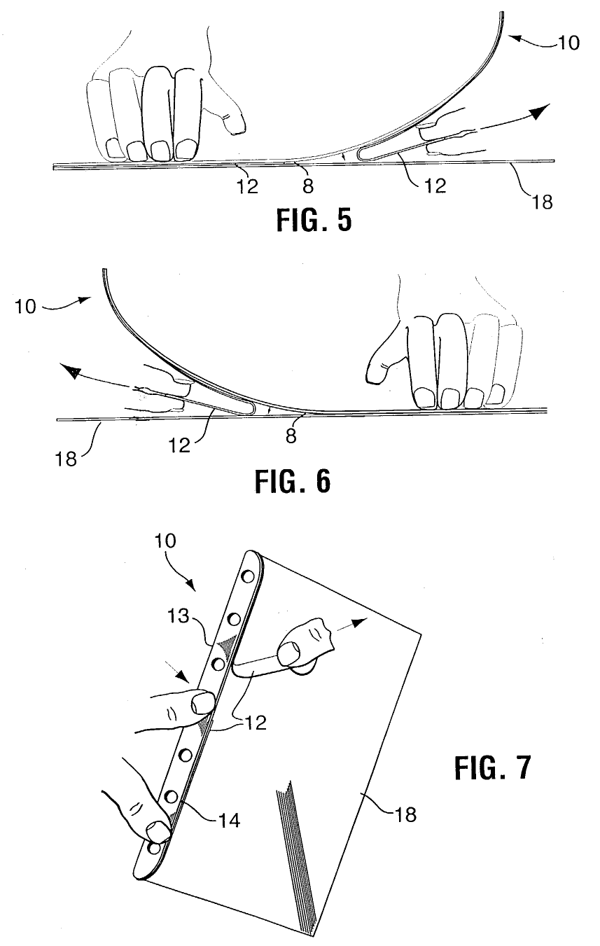

As best shown in FIG. 5, the aforementioned invention solves the problem of application of a reinforcement strip to a thin sheet of paper minimizing alignment problems. For instance, improper alignment of an adhesive strip onto a sheet of notebook paper results in adhesive covering a portion of the hole resulting in sticking of the sheets together or of residual adhesive spilling over the sides of the strip causing the sheets to stick together. Although adhesive could be used to cover the entire reinforcement strip, by utilizing adhesive along the periphery of the strips, along portions of the periphery of the strips, selected points between the holes, or along at least portions along a periphery of the interior side edge of the strip extending toward the paper, excess adhesive can be contained within the area of the reinforcement strip covering the page. Furthermore, as shown in FIGS. 5, 6, and 7 the use of the removable split backing with joining or overlapping tabs, enables the user to align and apply a portion of the reinforcement strip to a sheet of paper starting at other than the distal end of the strip, i.e. near the center of the page or next to one end. For instance, a portion of the paper can be held in position pressing a portion of the strip with backing against the sheet while peeling a portion of the backing from the strip and positioning and adhering the other end of the strip to the paper. This procedure is especially important when applying the strip to thin paper which tends to have a static charge, for the conventional method of peeling the backing from the entire strip often results in the user attempting to align the strip over the paper and static electricity causing the paper to pull upward meeting the strip prior to obtaining proper alignment of same. The instant invention provides a means for avoiding the problem of static cling and/or misalignment of strip.

The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

I claim:

1. A strip for reinforcing the lateral edge of a page that is insertable into a binder, said strip comprising:
a first outer face and a second opposite outer face, each one having a first and a second respective opposed longitudinal marginal edge terminating at respective opposite ends of said strip defining an outer periphery of said strip, said first longitudinal marginal edge being a straight line to correspond with a marginal edge of a page to which it is to be applied and wherein a selected length portion of said second marginal edge, proximate at least one of said opposite ends of the strip, tapers toward said first marginal edge in a direction toward the strip end associated therewith, a pressure sensitive adhesive on one face of said strip and a removable protective strip overlying said adhesive and readily peelable therefrom so as to expose said adhesive in preparation of placing said strip along an edge portion on a page in need of reinforcement.

2. The reinforcement strip as defined in claim 1, including a plurality of apertures through the strip and disposed in selected spaced apart relation longitudinally along the strip to accommodate its containment in a binder.

3. The reinforcement strip as defined in claim 1, wherein said adhesive covers the entire area of said one face.

4. The reinforcement strip as defined in claim 1 wherein said adhesive on said one face covers selected portions thereof.

5. The reinforcement strip as defined in claim 1 wherein said adhesive is pressure sensitive.

6. The reinforcement strip as defined in claim 1 wherein said second longitudinal edge tapers toward said first marginal edge at each of opposite ends of said strip.

7. The reinforcement strip as defined in claim 6 wherein said tapering edge is along a straight line.

8. The reinforcement strip as defined in claim 6 wherein said tapering edge is curved.

9. The reinforcement strip as defined in claim 1 wherein said strip is made of a paper coated with a polymer film.

10. The reinforcement strip as defined in claim 9 wherein said strip comprises a polymer material.
